(19) United States
(12) Patent Application Publication
(10) Pub. No.: US 2015/0118868 A1
(43) Pub. Date: Apr. 30, 2015

(54) ELECTRONIC DEVICE HAVING ELECTRIC CONNECTOR

(71) Applicant: Samsung Electronics Co., Ltd., Suwon-si (KR)

(72) Inventors: Jong-Chul CHOI, Suwon-si (KR); Han-Sik KIM, Seoul (KR); Seok-Hyun YOON, Yongin-si (KR); Gun LIM, Anyang-si (KR); Chang-Ryong HEO, Suwon-si (KR)

(21) Appl. No.: 14/294,617

(22) Filed: Jun. 3, 2014

(30) Foreign Application Priority Data
Oct. 25, 2013 (KR) 10-2013-0127650

(51) Int. Cl. H01R 13/62

(52) U.S. Cl. CPC H01R 13/6205
USPC 439/39

(57) ABSTRACT

An electronic device is provided. The electronic device includes a housing and a first connecting unit configured to be exposed out of the housing, wherein the first connecting unit includes an annular magnetic material formed to be exposed out of a surface of the housing, a depression at least partly formed by the annular magnetic material defining an opening thereof, and at least one male connector at least partially contained in the depression. The electronic device may be implemented in various embodiments.

### CROSS-REFERENCE TO RELATED APPLICATION(S)

This application claims the benefit under 35 U.S.C. §119(a) of a Korean patent application filed on Oct. 25, 2013 in the Korean Intellectual Property Office and assigned Serial number 10-2013-0127650, the entire disclosure of which is hereby incorporated by reference.

### TECHNICAL FIELD

The present disclosure relates to an electronic device. More particularly, the present disclosure relates to a connector for connecting electronic devices to one another.

### BACKGROUND

Typically, an electronic device refers to a device which performs a specific function corresponding to an installed program. Examples of an electronic device include devices such as a home appliance, an electronic diary, a portable multimedia player, a mobile communication terminal, a tablet Personal Computer (PC), an image/sound unit, a desktop/laptop computer, a navigation unit for a vehicle, and the like. Such an electronic device can output stored information in the form of a sound or an image. With the increased integration and the popularization of hyper-speed and high capacity wireless communication, a single mobile communication terminal now provides various functions. For example, an entertainment function such as a game, a multimedia function such as the reproduction of a music file and a video file, a communication and security function for mobile banking or the like, a scheduling function, an electronic wallet function, etc. are integrated into a single electronic device, in addition to a communication function. As the multimedia service or the entertainment function of the electronic device including the mobile communication terminal is enhanced, users tend to prefer an electronic device which is convenient for carrying and provided with a display unit having a large size.

The electronic device may be connected to another electronic device, for example an external device such as a personal computer, a charger, etc., in order to store a large-capacity file (e.g., a high-quality video file) to another electronic device, to upgrade software thereof, or to charge itself. Recently, the electronic devices may be connected to one another in a wireless communication scheme such as Bluetooth communication or Near Field Communication (NFC), and a wireless transmission technology may be commercially available. However, a wired connecting scheme is actually superior to a wireless connecting scheme in view of connection stability or electricity transmission efficiency.

An electronic device may have an electric connector in order to make a connection with another electronic device or a charger. The electric connector is provided with a plurality of connecting pins or connection terminals corresponding to the connecting pin. Such an electric connecting device has a connecting structure, for example a plug typed insertion connecting structure. The insertion connecting structure is constituted of a combination of a socket and a plug inserted in the socket, in which the plug inserted into the socket has a length long enough to maintain a stable connection.

In the construction of the wired type electric connector, the insertion type connecting structure may be polluted as an alien substance is introduced into the socket, and a removal of the alien substance is difficult. Further, since the plug has to be provided with connecting pins with a length long enough to provide an electric connection and to maintain a stable connection state, the plug has a significant possibility of being damaged by an external impact. Further, when the plug is misaligned with the socket during the combination and the separation of the plug with/from the socket, the electric connector may be damaged.

Accordingly, there is a need for an improved connector for an electronic device in order to make a connection with another electronic device.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an electric connector which is prevented from being polluted by an alien substance, or damaged by an external impact.

Another aspect of the present disclosure is to provide an electric connector which is easily connected and separated.

Still another aspect of the present disclosure is to provide an electric connector capable of maintaining a stable connecting state.

In accordance with an aspect of the present disclosure, an electronic device is provided. The electronic device includes a housing, and a first connecting unit configured to be exposed out of the housing, wherein the first connecting unit includes an annular magnetic material configured to be exposed out of a surface of the housing, a depression at least partly formed by the annular magnetic material defining an opening thereof, and at least one male connector at least partially contained in the depression.

In accordance with another aspect of the present disclosure, an electronic device is provided. The electronic device includes a housing, and a connecting unit provided in a surface of the housing to be exposed out of the housing, the connecting unit including a depression, a magnetic material extending along an edge of the depression, and at least one male connector formed in the depression.

In accordance with still another aspect of the present disclosure, an electronic device is provided. The electronic device includes a housing, a connecting unit configured in the housing to be exposed, and a connector detachably coupled with the connecting unit, wherein the connecting unit includes a magnetic material disposed on a surface of the housing to be exposed, a depression region at least partly surrounded by the magnetic material, and at least one connecting pin provided in the protruding region.

In accordance with still another aspect of the present disclosure, an electronic device is provided. The electronic device includes a cable electrically connected to an external electric plug, and a connector connected to an end of the cable, wherein the connector includes a protrusion which has a substantially annular shape and includes a substance to be attracted by a magnetic material or a magnet, a depression region at least partly formed in the protrusion, and at least one female connector arranged in the depression region.

Other aspects, advantages, and salient features of the disclosure will become apparent to those skilled in the art from the following detailed description, which, taken in conjunction with the annexed drawings, discloses various embodiments of the present disclosure,

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a perspective view illustrating an electric connector of a connecting device according to a first embodiment of the present disclosure, in which an electronic device is provided with the electric connector;

FIG. 2 is a front view illustrating an electric connector of a connecting device according to the first embodiment of the present disclosure;

FIG. 3 is a front view illustrating a receptacle of a connecting device according to the first embodiment of the present disclosure;

FIG. 4 is a longitudinally sectional view illustrating a receptacle of a connecting device according to the first embodiment of the present disclosure;

FIG. 5 is a view illustrating an electric connector and a receptacle of a connecting device according to the first embodiment of the present disclosure, before the electric connector is coupled to the receptacle;

FIG. 6 is a view illustrating a coupling of an electric connector to a receptacle of a connecting device according to the first embodiment of the present disclosure;

FIG. 7 is a perspective view illustrating a receptacle of a connecting device according to a second embodiment of the present disclosure;

FIG. 8 is an exploded perspective view illustrating a receptacle of a connecting device according to the second embodiment of the present disclosure;

FIG. 9 is a view illustrating an electric connector and a receptacle of a connecting device according to the second embodiment of the present disclosure, before the electric connector is coupled to the receptacle;

FIG. 10 is a view illustrating a coupling of an electric connector to a receptacle of a connecting device according to the second embodiment of the present disclosure;

FIG. 11 is a front view illustrating an electric connector of a connecting device according to a third embodiment of the present disclosure;

FIG. 12 is a front view illustrating an electric connector of a connecting device according to the third embodiment of the present disclosure;

FIG. 13 is a view illustrating an electric connector and a receptacle of a connecting device according to the third embodiment of the present disclosure, before the electric connector is coupled to the receptacle; and

FIG. 14 is a view illustrating a coupling of an electric connector to a receptacle of a connecting device according to the third embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

A connecting device according to the various embodiments of the present disclosure, for example an electric connector, may include conductive members (i.e., connecting terminals) arranged to protrude from a surface thereof, and an annular magnetic body fit to a periphery of the protrusion. The protrusion may be annularly formed. According to the various embodiments, the magnetic body may be a magnet with only one polarity. The magnetic body with one polarity is arranged, thereby preventing a generation of a repulsive force due to the polarities of the magnetic body. Further, a coupling of the connector to a connecting unit (i.e., a receptacle) may be stably implemented. In a certain embodiment, the protrusion may have an asymmetric shape. For example, the connecting terminals are arranged in a row on the protrusion. For example, the protrusion may have an asymmetric shape with respect to an axial direction in which the connecting terminals are arranged or with respect to a direction perpendicular to the axial direction.

In an arrangement of the magnetic body in the connecting device according to the various embodiments of the present disclosure, the protrusion may include a magnetic material or a material attracted by a magnet. In this case, a magnetic body disposed in a depression opposite to the protrusion may be attracted to the magnetic body or the magnet arranged on the protrusion.

In the description of the various embodiments of the present disclosure, the ‘magnetic body’ includes a material which has magnetism when it is disposed in a magnetic field, as well as a magnet with magnetic force. For example, the ‘magnetic body’ may include a general permanent magnet, a body made of a ferromagnetic substance, a metal body containing iron, and the like.

Further, the connecting device according to the various embodiments of the present disclosure may include a receptacle engaged with the connector.

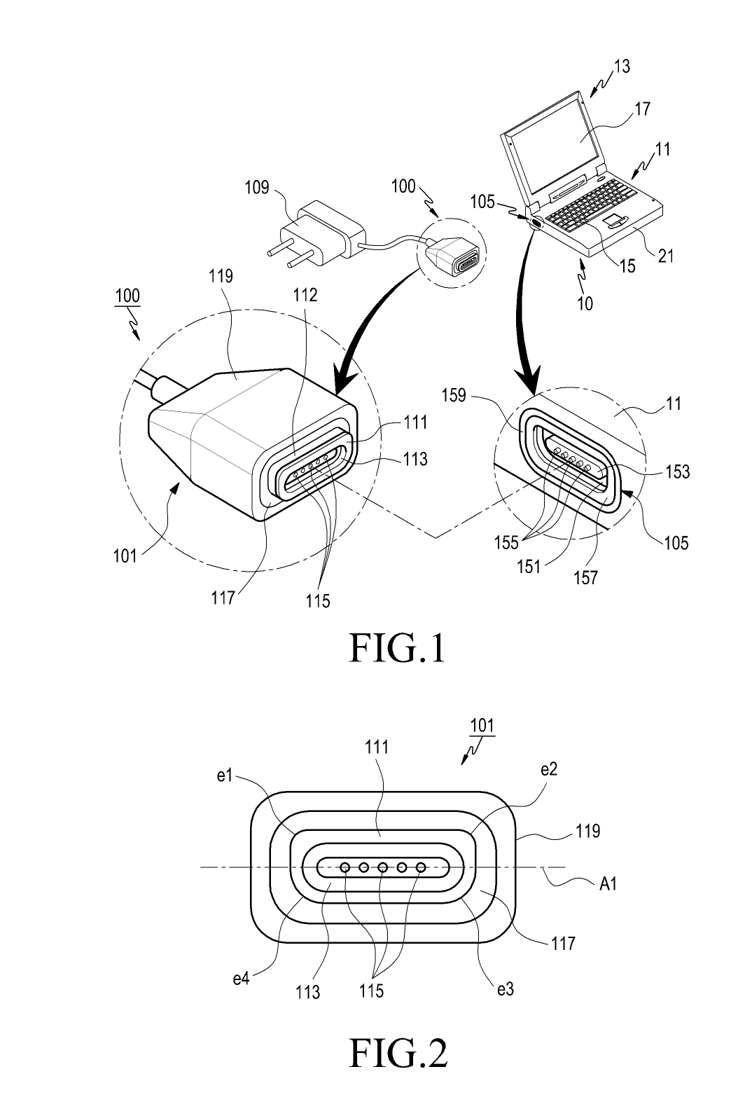

FIG. 1 is a perspective view illustrating an electric connector of a connecting device according to a first embodiment of the present disclosure, in which an electronic device is provided with the electric connector.

Referring to FIG. 1, a laptop computer is exemplarily illustrated as an electronic device 10, which is provided with a body 11 having an input unit 15 such as a keyboard and the like arranged thereon, and a display unit 13 pivotally connected to the body and having an output unit 17. However, the principle and configuration of the connecting device according to the various embodiments of the present disclosure may be easily applied to another electronic device. The present disclosure may include various electronic devices having the connector. For example, the electronic device according to the present disclosure may be one of a smart phone, a tablet Personal Computer (PC), a mobile phone, a video phone, an e-book reader, a desktop PC, a netbook computer, a Personal Digital Assistant (PDA), a Portable Multimedia Player (PMP), an MP3 player, a mobile medical appliance, an electronic bracelet, an electronic necklace, an electronic appcessory, a camera, a wearable device, an electronic clock, a wrist watch, home appliances including a refrigerator, an air conditioner, a vacuum cleaner, an oven, a microwave oven, a washing machine, an air cleaner, and the like, an artificial intelligence robot, a television, a Digital Video Disk (DVD) player, an audio player, various medical appliances including a Magnetic Resonance Angiography (MRA) device, a Magnetic Resonance Imaging (MRI) device, a Computerized Tomography (CT) device, an ultrasonography device, and the like, a navigation device, a Global Positioning System (GPS) receiver, an Event Data Recorder (EDR), a Flight Data Recorder (FDR), a set-top box, a TV box such as HomeSync™ of SAMSUNG Electronics, Co., Apple TV™ of APPLE, Co., and Google TV™ of Google, Co., an electronic dictionary, an infotainment device for a vehicle, an electronic equipment for a ship such as a navigation device, a gyrocompass, an avionic device, a security device, an electronic cloth, an electronic key, a camcorder, a game console, a Head-Mounted Display (HMD) unit, a flat panel display device, an electronic frame, an electronic album, an electronic board, an electronic signature receiving device, and a protector, or combinations thereof. It is obvious to a person skilled in the art that the electronic device according to the present disclosure is not limited to the above-mentioned devices.

The connecting device 100 may include a first connecting unit, i.e. a receptacle 105, exposed from a portion of a body housing 21 constituting a body of the electronic device 10, and a second connecting unit, i.e. a connector 101, detachably connectable to the first connecting unit. The connector 101 may be provided at an end of a cable connected to an external electric power plug, for example, a charger 109. In a certain embodiment, the cable provided with the connector 101 may have a Universal Serial Bus (USB) connector at the other end thereof. The receptacle 105 may be exposed out of a surface of the body housing 21 of the electronic device 10. The connector is connected to the electronic device 10 through the receptacle 105. Therefore, the receptacle 105 may be mounted on an externally exposed surface of the body housing 21.

The connector 101 may have a protrusion 111 formed on a surface thereof. The protrusion 111 defines a depression region 113 therein, and connecting terminals 115 are arranged in the depression region 113. For example, the connector 101 may include one or more female connectors, i.e. the connecting terminals 115. The protrusion 111 may be provided in the form of a partially opened loop or a closed loop surrounding the region in which the connecting terminals 15 are arranged, i.e. the depression region 113. A depth from an end surface of the protrusion 111 to the depression region 113 may be smaller than a height of the protrusion 111 protruding from a surface of the connector 101. The connector 101 may include a magnetic body 117 which at least partially surrounds a periphery of the protrusion 111 on the surface thereof. In the configuration of the connector 101 of the connecting device 100 according to the various embodiments, the magnetic body 117 may be a magnet with one polarity. The connector 101 may include a housing 119 made of an insulation material. The magnetic body 117 and the connecting terminals 115 may be disposed on a surface of the housing 119, and the protrusion 111 may be integrally formed on the housing 119.

In a certain embodiment, the connecting device 100 may further include a ground member 112 which is provided to surround at least a part of the periphery of the protrusion 111. The ground member 112 reinforces strength of the protrusion 111, and also provides a ground to the connector 101, thereby enhancing electrical safety of the connecting device 100.

FIG. 2 is a front view illustrating an electric connector of a connecting device according to the first embodiment of the present disclosure.

Referring to FIG. 2, the plurality of connecting terminals 115 constituting the female connector are arranged in a row in one direction, i.e. a direction perpendicular to a longitudinal axis of the connector 101. The number of the connecting terminals 115 may be changed according to a use of the connector 101, i.e. a use of as a charger or for a data transmission. As described above, the protrusion 111 may be provided in the form of the closed loop surrounding the depression region 113, and the magnetic body 117 also may be provided in the form of the closed loop surrounding the protrusion 111. The protrusion 111 may be asymmetrically formed around an axis A1 on which the connecting terminals 115 are arranged. For example, as shown in FIG. 2, corners e1 and e2 connecting an upper surface of the protrusion 111 to both side surfaces are formed to have a different curvature from that of corners e3 and e4 connecting a lower surface of the protrusion 111 to both side surfaces.

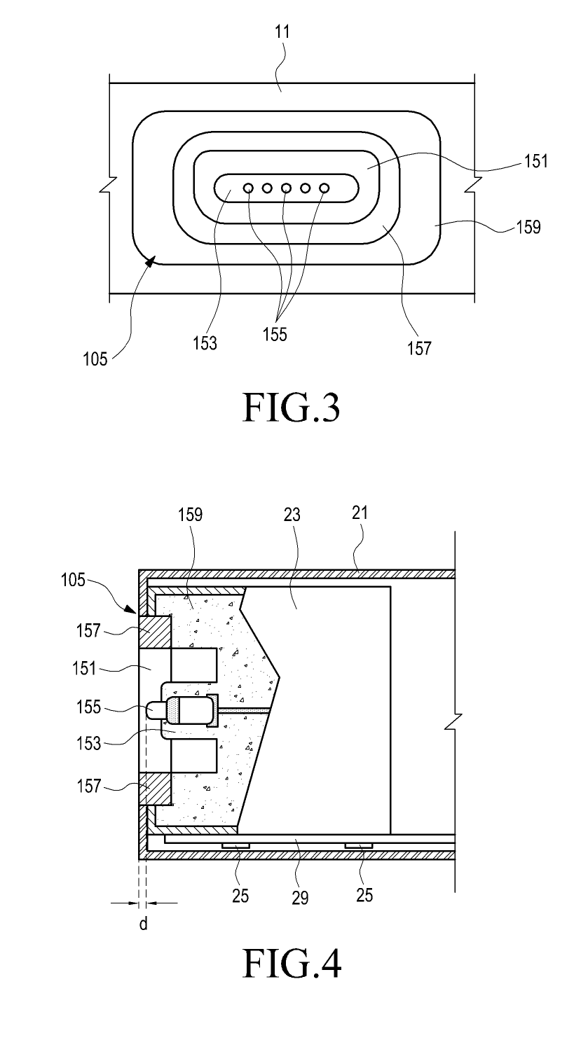

FIG. 3 is a front view illustrating a receptacle of a connecting device according to the first embodiment of the present disclosure. FIG. 4 is a longitudinally sectional view illustrating a receptacle of a connecting device according to the first embodiment of the present disclosure.

Referring to FIGS. 3 and 4, the first connecting unit, i.e. the receptacle 105, has a depression 151 formed on the surface thereof. The depression 151 has a protruding region 153 formed therein, and connecting pins 155 are arranged in the protruding region 153 in a protruding state. For example, the receptacle 105 may include at least one male connector enclosed by the protruding region 153 in the depression 151. The depression 151 may be formed to correspond to the protrusion 111, and the protruding region 153 may be formed to correspond to the depression region 113. The depression 151 may be provided in the form of a closed loop surrounding the region, i.e. the protruding region 153, in which the connecting pins 155 are arranged. A height of the protruding region 153 protruding from a bottom of the depression 151 may be smaller than a depth of the depression 151 in the surface of the receptacle 105. A second magnetic body 157 may be provided along a periphery of the depression 151 on the surface of the receptacle 105. The second magnetic body 157 generates magnetism in correspondence to the magnetic body 117 provided to the connector 101. For example, if the magnetic body 117 is a magnet with polarity of the N pole, the second magnetic body 157 may be made of a metal material with magnetism or a magnet with polarity of the S pole. In a certain embodiment, if the magnetic body 117 is a metal material with magnetism, the second magnetic body 157 may be made of a magnet having polarity of any one of the N pole and the S pole.

The male connectors, i.e. the connecting pins 155, may be pogo pins which are partially made to appear and disappear by an elastic force of an elastic body contained therein. In the arrangement of the connecting pins 155 in the protruding region 153, the connecting pins 155 may be arranged in the depression 151 so that the ends thereof are located under the surface of the housing 159 of the receptacle 105. A depth from the surface of the housing 159 to the ends of the connecting pins 155 may be differently designed according to the various embodiments. Although another metal material is attached to the receptacle 105 by the second magnetic body 157, short-circuits between the connecting pins 155 can be prevented because the ends of the connecting pins 155 are placed in the depression 151. Similarly, in the structure of the connector 101 as shown in FIG. 2, the connecting terminals 115 are disposed under the bottom of the depression region 113, thereby preventing short-circuits between the connecting terminals 115 which may be caused by alien substances.

In fitting the above-mentioned receptacle 105 to the electronic device 10, the receptacle 105 is fixed in the housing 21 of the body while being enclosed by a chassis 23. The chassis 23 may provide an electric insulation, and also provide a means for fixing the receptacle 105 in the housing 21 of the body. For example, the chassis 23 may be provided with fixing pins 25. Accordingly, the chassis 23 may be fixed to a circuit board 29 disposed in the housing 21 of the body.

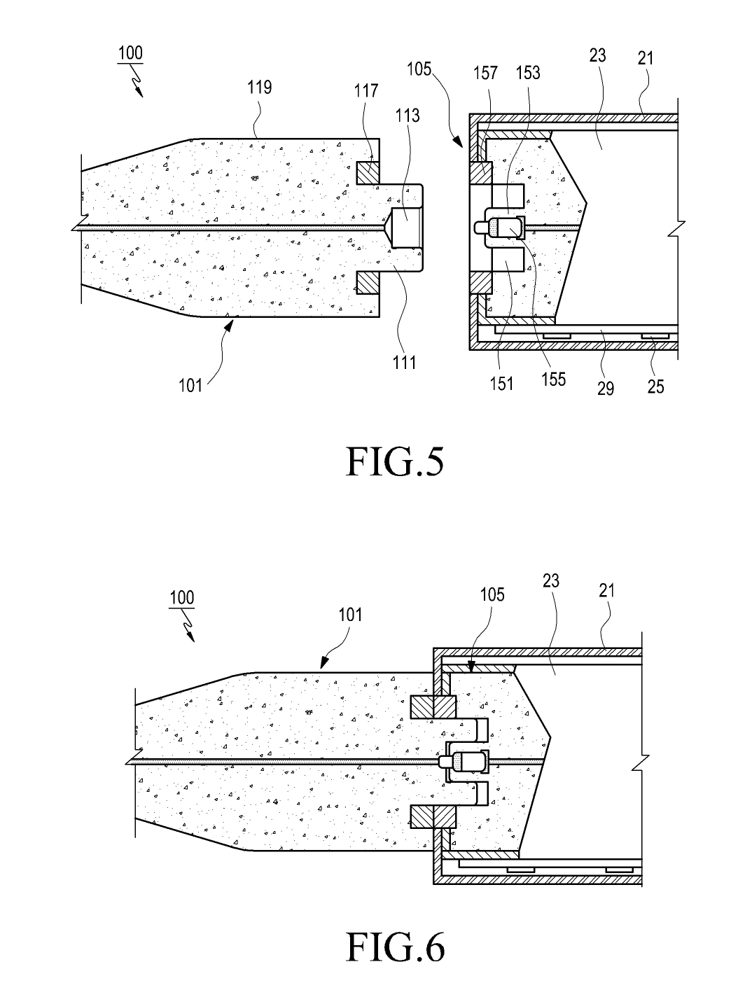

FIG. 5 is a view illustrating an electric connector and a receptacle of a connecting device according to the first embodiment of the present disclosure, before the electric connector is coupled with the receptacle. FIG. 6 is a view illustrating a coupling of an electric connector with a receptacle of the connecting device according to the first embodiment of the present disclosure.

As shown in FIGS. 5 and 6, the connecting device 100 may provide an electrical connection when the connector 101 is coupled with the receptacle 105. The connector 101 is coupled with the receptacle 105 in such a manner that the protrusion 111 of the connector 101 is engaged with the depression 151 of the receptacle 105 and the depression region 113 of the connector 101 is engaged with the protruding region 153 of the receptacle 105. As described above, magnetic attraction between the magnetic body 117 of the connector 101 and the second magnetic body 157 of the receptacle 105 enables the connector 101 to be rigidly coupled with the receptacle 105. The magnetic body 117 and the second magnetic body 157 may be engaged with each other. If they are not, they may generate attraction capable of coupling the connector 101 with the receptacle 105.

It was described above that the connecting terminals 115 are disposed deeper than the depression region 113, and the connecting pins 155 are arranged in the protruding region 153 in the protruding state. When the connector 101 is coupled with the receptacle 105, the end of the protruding region 153 is inserted in the depression region 113 to contact the bottom of the depression region 113. A length of the connecting pin 155 extending from the end of the protruding region 153 may be greater than a depth from the depression region 113 to the connecting terminals 115. Accordingly, when the connector 101 is coupled with the receptacle 105, the connecting pins 155 may stably contact the connecting terminals 115 respectively.

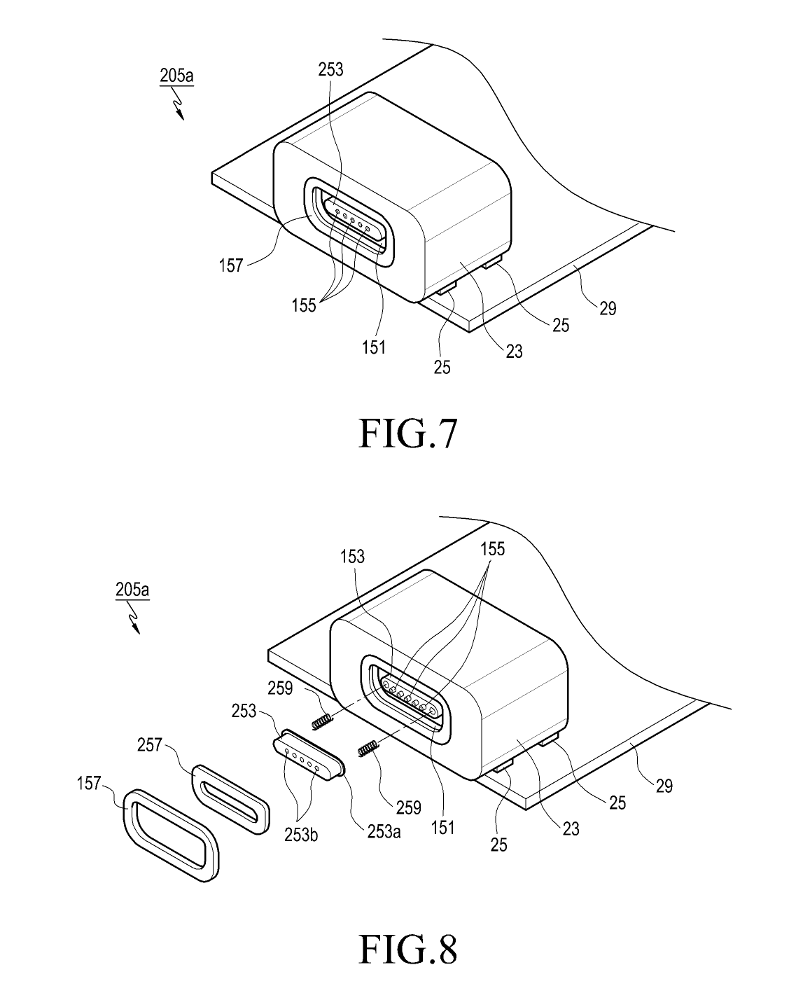

FIG. 7 is a perspective view illustrating a receptacle of a connecting device according to a second embodiment of the present disclosure. FIG. 8 is an exploded perspective view illustrating a receptacle of a connecting device according to the second embodiment of the present disclosure.

As shown in FIGS. 7 and 8, a receptacle 205a includes a cover member 253 enclosing and reciprocally coupled with the protruding region 153. In the description of the receptacle 205a according to the embodiment, identical reference numerals denote structural elements which can be easily understood through the preceding embodiment or are omitted, and the description of the structural elements described above with relation to the preceding embodiment will be omitted.

The cover member 253 is provided to enclose the protruding region 153 in the depression 151, and is reciprocally installed in a protruding direction of the protruding region 153. The cover member 253 is received in the protruding region 153 in such a manner that an open end thereof is firstly inserted in the protruding region 153, and has a flange 253a formed on an outer peripheral surface of the open end thereof. The cover member 253 has through-holes 253b formed in an upper surface thereof. The through-holes 253b may provide pathways through which the connecting pins 155 protrude to the outside respectively.

The receptacle 205a further includes elastic members 259 for supporting the cover member 253. The electric members 259 may be arranged in parallel with the connecting pins 155 in the protruding region 153. The elastic members 259 may provide elasticity to the cover member 253 in a direction that the cover member 253 receives the connecting pins 155. Accordingly, if an external force is not applied to the cover member 253, for example, the connector is not coupled with the receptacle 205a, the cover member 253 receives and protects the connecting pins 155.

The receptacle 205a is provided with a dummy plate 257, so as to restrict the cover member 253 in the depression 151. The dummy plate 257 may be fit to the cover member 253 to surround a periphery of the cover member 253 and fixed to the bottom of the depression 151 while supporting the flange 253a. Therefore, the cover member 253 receives the elasticity from the elastic member 259 in a direction of receiving the connecting pins 155, i.e. in a direction of departing from the depression, while being supported by the dummy plate 257 so as to be restricted in the depression 151.

The receptacle 205a is also provided with fixing pins 25, and is fixed to the circuit board 29 through the fixing pins 25.

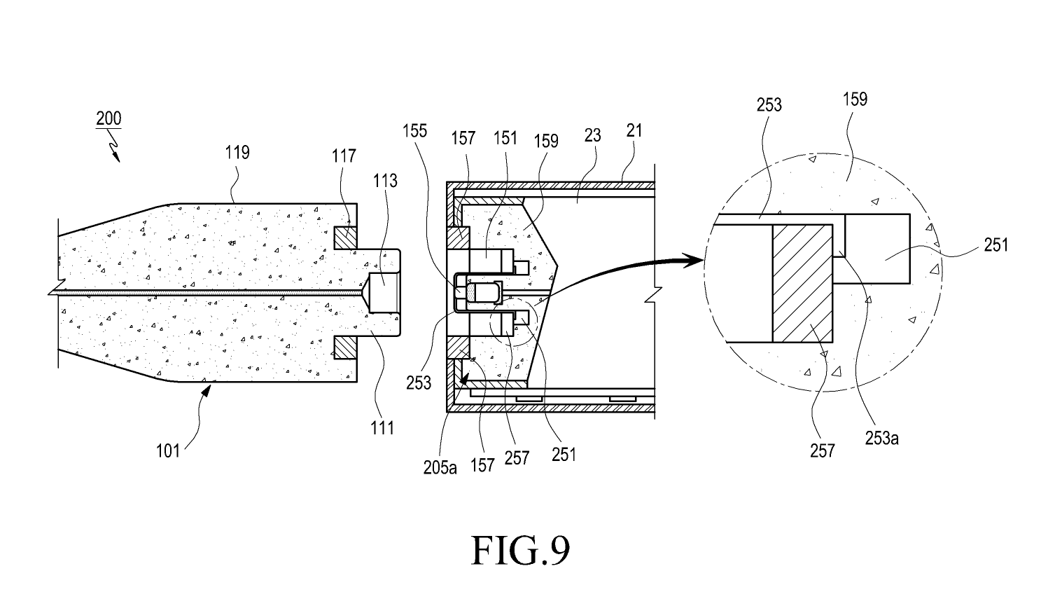

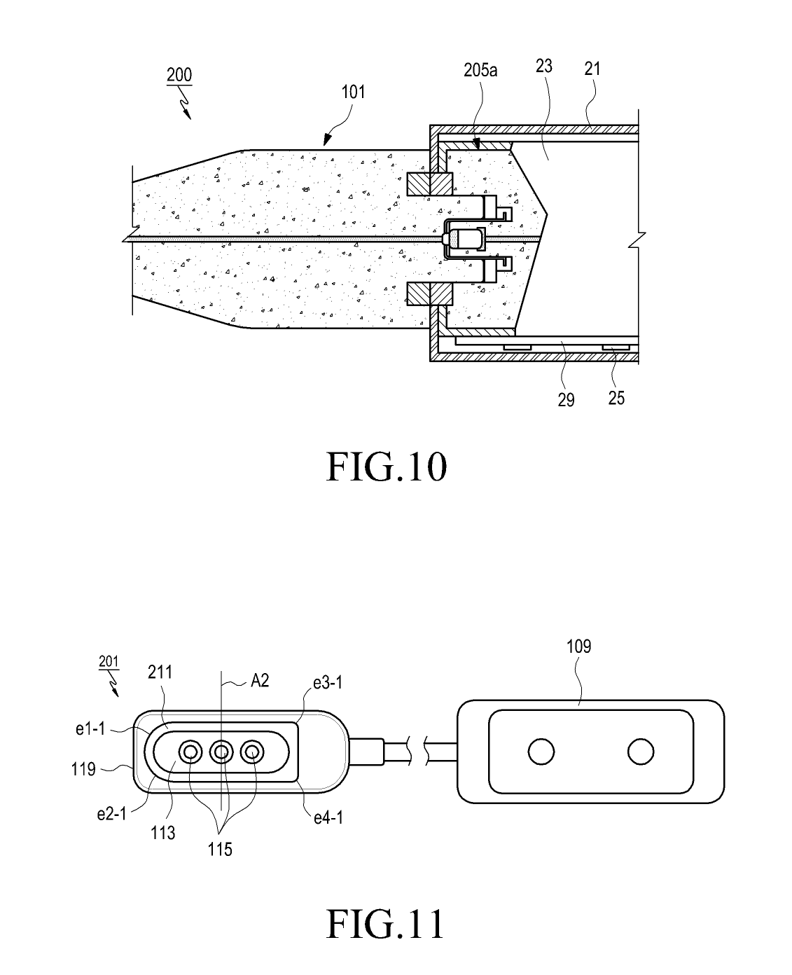

FIG. 9 is a view illustrating an electric connector and a receptacle of a connecting device according to the second embodiment of the present disclosure, before the electric connector is coupled to the receptacle. FIG. 10 is a view illustrating a coupling of an electric connector to a receptacle of a connecting device according to the second embodiment of the present disclosure.

Referring to FIGS. 9 and 10, a connecting device 200 including the receptacle 205a may further include an avoiding groove 251 formed in the bottom of the depression 151. The avoiding groove 251 is formed in the bottom of the depression 151 to surround the protruding region 153, and has a depth deeper than the bottom of the depression 151. When the cover member 253 is coupled so as to receive the protruding region 153, the flange 253a of the cover member 253 may be placed in the avoiding groove 251. For example, when the dummy plate 257 is fixed to the bottom of the depression 151, the flange 253a may be restricted in the avoiding groove 151 by means of the dummy plate 257.

When the cover member 253 reciprocally moves in the depression 151, the flange 253a reciprocally moves along with the cover member 253 in the avoiding groove 251. When the cover member 253 is moved by the elasticity of the elastic member 259 in a direction of departing from the depression 151, the flange 253a may be stopped by an interference of the dummy plate 257. Accordingly, the cover member 253 may be restricted and maintained by means of the flange 253a and the dummy plate 257 within the depression.

FIG. 9 shows the connector before being coupled with the receptacle 205a. The external force is not applied to the cover member 253 before the connector 101 is coupled to the receptacle 205a. Accordingly, the cover member 253 is supplied with the elasticity of the elastic member 259 while being maintained in a direction of departing from the depression 151. At this time, as the flange 253a is restricted by the dummy plate 257, the cover member 253 may be restricted and maintained within the depression. In the state that the flange 253a is stopped by the interference of the dummy plate 257, the connecting pins 155 may be received within the cover member 253. Therefore, the connecting pins 155 are prevented from contacting alien substances such as a metal material.

FIG. 10 shows the coupling of the connector 101 with the receptacle 205a. When the connector 101 is coupled with the receptacle 205a, the cover member 253 is retreated by interference of the bottom of the depression region 113 and the flange 253a is further moved in the avoiding groove 251. As the cover member 253 is moved, the connecting pins 155 protrude out of the cover member 253 through the through-holes 253b respectively. In the state of protruding to the outside of the cover member 253, the connecting pins 155 come in contact with and are electrically connected to the connecting terminals 115 respectively. When the connector 101 is coupled with the receptacle 205a, the protrusion 111 is engaged with the depression 151 while the protruding region 153 is engaged with the depression region 113. Further, the magnetic attraction between the magnetic body 117 provided to the connector 101 and the second magnetic body 157 provided to the receptacle 205a makes the connector 101 and the receptacle 205a to be stably connected to each other.

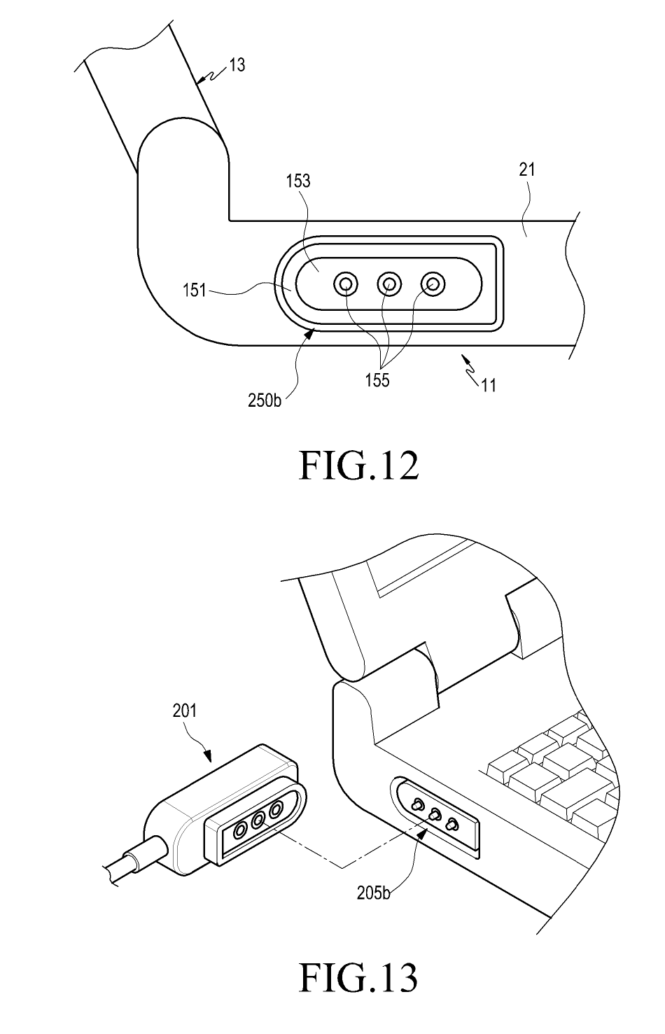

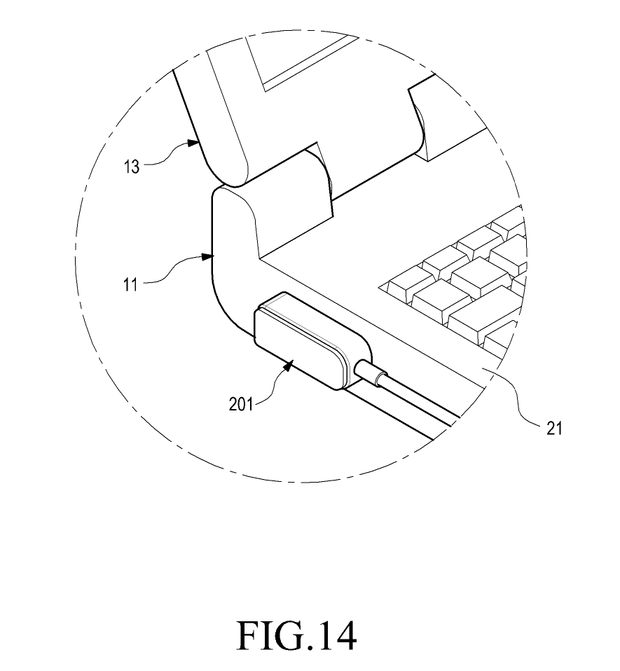

FIG. 11 is a front view illustrating an electric connector of a connecting device according to a third embodiment of the present disclosure. FIG. 12 is a front view illustrating an electric connector of a connecting device according to the third embodiment of the present disclosure. FIG. 13 is a view illustrating an electric connector and a receptacle of a connecting device according to the third embodiment of the present disclosure, before the electric connector is coupled with the receptacle. FIG. 14 is a view illustrating a coupling of an electric connector with a receptacle of a connecting device according to the third embodiment of the present disclosure.

In the description of the connector 201 and the receptacle 205b shown in FIGS. 11 to 14, identical reference numerals to those of the preceding embodiments denote the structural elements which can be easily understood through the preceding embodiments, and the description of the structure will be omitted.

In the connecting device of the embodiment shown in FIGS. 11 and 12, the connector 201 may include a protrusion 211 which is asymmetric around an axis A2 perpendicular to an axial direction in which the connecting terminals 115 are arranged. For example, in FIG. 11, corners e1-1 and e2-1 connecting a left surface to upper and lower surfaces of the protrusion 211 may have a curvature different from that of corners e3-1 and e4-1 connecting a right surface to the upper and lower surfaces of the protrusion 211. The receptacle 205b corresponding to the connector 201 further may have a depression 151 with a shape corresponding to that of the protrusion 211.

As described above, as the protrusion of the connector and the depression of the receptacle have corresponding shapes and are formed asymmetrically, a user can easily recognize a coupling direction of the connector and the receptacle.

On the other hand, with respect to the connector and the receptacle according to the preceding various embodiments, it is exemplarily described that the magnetic material is disposed on the periphery of the protrusion or the depression. However, the structure of the present disclosure is not limited thereto.

For example, in the connecting device according to the third embodiment of the present disclosure, the protrusion 211 of the connector 201 and the protruding region 153 of the receptacle 205b may be wholly or partially made of the magnetic material. For example, the magnetic material may be contained in the protrusion 211 and the protruding region 153. As described above, the magnetic material included in the connecting device according to the various embodiments of the present disclosure includes a magnet with a single polarity, or a material with magnetism when it is placed in a magnetic field. However, in the arrangement of the magnetic material on the connecting device according to the various embodiments of the present disclosure, magnets, or a magnet and a magnetic material with magnetism are arranged on the connector and the receptacle respectively, so that magnetic attraction may be generated between the connector and the receptacle.

In the connecting device according to various embodiments of the present disclosure, the magnetic material provides a coupling force, and a length of the protrusion and a depth of the depression corresponding to the protrusion can be reduced. Accordingly, the connecting device can be prevented from being damaged by external impact or polluted by an alien substance. Further, although the length of the protrusion is reduced, the connector and the receptacle can be easily aligned and coupled by the magnetic material, thereby providing a sufficient coupling force.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic device comprising:
a housing; and
a first connecting unit configured to be exposed out of the housing,
wherein the first connecting unit includes an annular magnetic material configured to be exposed out of a surface of the housing, a depression at least partly formed by the annular magnetic material defining an opening thereof, and at least one male connector at least partially contained in the depression.

2. The electronic device as claimed in claim 1, wherein the first connecting unit further includes a protruding region formed in the depression which surrounds at least a part of the male connector.

3. The electronic device as claimed in claim 2, wherein the first connecting unit further includes a cover member reciprocally coupled with the protruding region while surrounding the protruding region, and the male connector is received in or exposed out of the cover member as the cover member is reciprocally moved.

4. The electronic device as claimed in claim 3, wherein the first connecting unit further includes an elastic member which supports the cover member, the elastic member providing the cover member with an elastic force which acts in a direction of receiving the male connector.

5. The electronic device as claimed in claim 1, further comprising a second connecting unit configured to be detachably coupled with the first connecting unit.

6. The electronic device as claimed in claim 5, wherein the second connecting unit includes a magnetic material at least partly contacting the annular magnetic material, and a female connector corresponding to the male connector.

7. The electronic device as claimed in claim 5, wherein the second connecting unit includes a protrusion inserted into the depression.

8. The electronic device as claimed in claim 7, wherein the magnetic material is provided at an end or near the end of the protrusion.

9. The electronic device as claimed in claim 1, wherein the at least one male connector comprises a plurality of male connectors arranged along an axial direction, and the depression has an asymmetric shape around an axis along which the male connectors are arranged.

10. The electronic device as claimed in claim 1, wherein the at least one male connector comprises a plurality of male connectors arranged along an axial direction, and the depression has an asymmetric shape around an axis perpendicular to an axis along which the male connectors are arranged.

11. The electronic device as claimed in claim 1, wherein the at least one male connector comprises a plurality of male connectors, and the depression has a closed loop shape to surround the arrangement of the male connectors.

12. The electronic device as claimed in claim 1, wherein the annular magnetic material has a closed loop shape to surround the depression.

13. An electronic device comprising:
a housing; and
a connecting unit provided in a surface of the housing to be exposed out of the housing, the connecting unit including a depression, a magnetic material extending along an edge of the depression, and at least one male connector formed in the depression.

14. The electronic device as claimed in claim 13, further comprising a connector correspondingly coupled with the connecting unit and including another magnetic material to generate magnetic attraction along with the magnetic material.

15. The electronic device as claimed in claim 14, wherein at least one of the magnetic material of the connecting unit and the magnetic material of the connector includes a magnet with single polarity.

16. The electronic device as claimed in claim 14, wherein the connector comprises a protrusion correspondingly engaged with the depression, a depressed region formed in the protrusion, and female connectors arranged in the depressed region, and the female connectors contact the male connectors respectively when the connector is coupled with the connecting unit.

17. The electronic device as claimed in claim 16, wherein the female connectors comprise a plurality of female connectors arranged along an axial direction, and the protrusion has an asymmetric shape around an axis perpendicular to an axis along which the female connectors are arranged.

18. The electronic device as claimed in claim 16, wherein the connector further comprises a ground member disposed to surround at least a part of a peripheral surface of the protrusion.

19. An electronic device comprising:
a housing;
a connecting unit configured in the housing to be exposed; and
a connector detachably coupled with the connecting unit,
wherein the connecting unit includes a magnetic material disposed on a surface of the housing to be exposed, a depression region at least partly surrounded by the magnetic material, and at least one connecting pin provided in the protruding region.

20. The electronic device as claimed in claim 19, wherein the connector includes a member having a substance to be attracted by a magnetic force at a position near the magnetic material of the connecting unit when being coupled with the connecting unit, and a conductive member electrically contacting the connecting pin.

21. An electronic device comprising:
a cable electrically connected to an external electric plug; and
a connector connected to an end of the cable,
wherein the connector includes a protrusion which has a substantially annular shape and includes a substance to be attracted by a magnetic material or a magnet, a depression region at least partly formed in the protrusion, and at least one female connector arranged in the depression region.

22. The electronic device as claimed in claim 21, wherein the at least one female connector comprises a plurality of female connectors arranged along an axial direction, and the depression has an asymmetric shape around an axis along which the female connectors are arranged.

23. The electronic device as claimed in claim 21, wherein the at least one female connector comprises a plurality of female connectors arranged along an axial direction, and the depression has an asymmetric shape around an axis extending in a direction perpendicular to an axis along which the female connectors are arranged.

24. The electronic device as claimed in claim 21, wherein the protrusion has a closed loop shape which surrounds the arrangement of the at least one female connector.

25. The electronic device as claimed in claim 21, wherein the substance to be attracted by a magnetic material or a magnet is disposed in the form of a closed loop surrounding the depression region.

26. The electronic device as claimed in claim 21, wherein the at least one female connector includes connecting terminals arranged in the depression region.
